(19) United States
(12) Patent Application Publication
(10) Pub. No.: US 2003/0057812 A1
(43) Pub. Date: Mar. 27, 2003

(54) Double ellipsoid light bulb using total internal reflection

(76) Inventors: James K. Guy, Mesa, AZ (US); Arvi Jeffery, Solon, OH (US)

Correspondence Address: HARNESS, DICKEY & PIERCE, P.L.C., P.O. BOX 828, BLOOMFIELD HILLS, MI, 48303, US

(21) Appl. No.: 09/943,783

(22) Filed: Aug. 31, 2001

(51) Int. Cl. H01J 5/16; H01K 1/26

(52) U.S. Cl. 313/113

(57) ABSTRACT

An light bulb is provided and arranged to support total internal reflection. The walls of the light bulb elliptically extend outwardly to opposite ends from an equatorial plane dividing a central spherical cavity. A light emitting medium is disposed within the central spherical cavity. The light emitting medium is maintained between oppositely extending electrodes and is perpendicularly aligned along a centerpoint of the equatorial plane of the central spherical cavity.

### FIELD OF THE INVENTION

The present invention relates generally to light emitting devices, and more particularly to a total internal reflection light bulb.

### SUMMARY OF THE INVENTION

The present invention provides a light bulb using total internal reflection to provide more efficient focused output. The body of the light bulb is arranged having walls extending in an elliptical contour from a central focal plane to opposite ends. A light source includes a light-emitting medium or filament that extends between oppositely extending electrodes and is positioned to axially extend across a central cavity of the body.

In a preferred embodiment, the light bulb includes a solid body portion having a central cavity. The central cavity includes rare earths or additives used to produce different colors according to the application. The outer walls of the solid body portion extend elliptically in opposite directions to provide total internal reflection. Light emitted from the light source reflects off the outer walls of the light bulb and is directed toward the focus of each elliptical half of the bulb.

Further areas of applicability of the present invention will become apparent from the detailed description provided hereinafter. It should be understood however that the detailed description and specific examples, while indicating a preferred embodiment of the invention, are intended for purposes of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description and the accompanying drawings, wherein:

FIG. 1 is a perspective view of the dual ellipsoid light bulb according to a first embodiment;

FIG. 2 is a perspective view of the dual ellipsoid light bulb according to a second embodiment;

FIG. 3 is a sectional side view of a dual ellipsoid light bulb along line III-III of FIG. 1;

FIG. 4 is a ray trace of the light bulb of the first embodiment;

FIG. 5 illustrates a basic ellipse;

FIG. 6 is a semi-ellipse illustrating a ray trace having total internal reflection according to the teachings of this invention;

FIG. 7 is a side view of the dual ellipsoid light bulb according to a second embodiment; and

FIG. 8 is a ray trace of the light bulb of the second embodiment.

### DETAILED DESCRIPTION OF THE PREFERRED EMBODIMENTS

With initial reference to the view of FIG. 1, the light bulb according to the preferred embodiment is illustrated and generally identified at reference 10. The light bulb 10 is defined by body 20 having walls 22 and includes a light source 12 disposed therein. The light source 12 is positioned between electrodes 14.

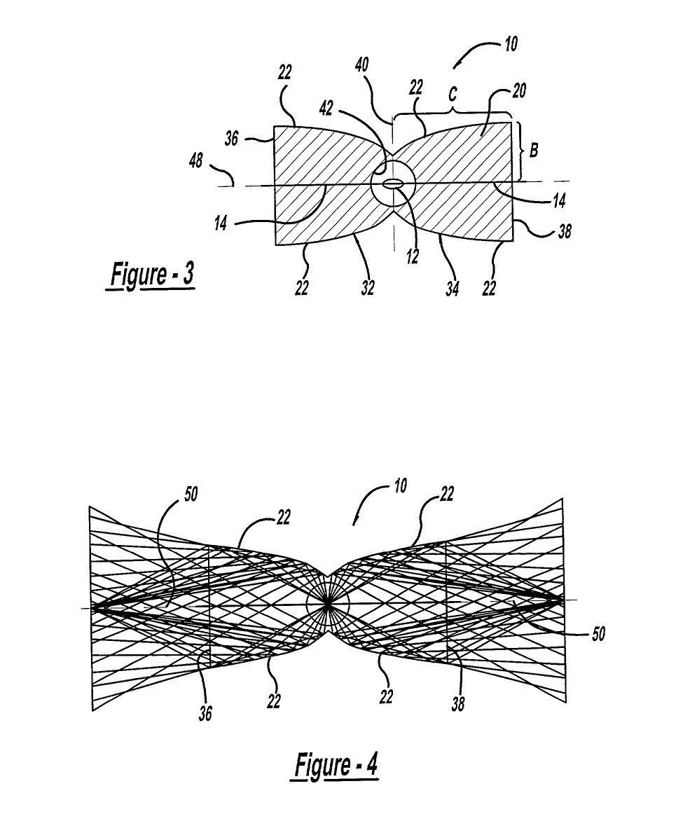

With continued reference to FIG. 1 and additional reference to FIGS. 3 and 4, the light bulb 10 will be described in greater detail. Body 20 is configured to allow light 50 emitted from light source 12 to reflect off walls 22 by total internal reflection. Walls 22 are defined by overlapping semi-ellipsoids 32, 34, which are generally ellipsoids truncated at their axis of symmetry. As such, walls 22 extend toward opposite ends 36, 38 from a first equatorial plane 40 extending through the diameter of central spherical cavity 42. First equatorial plane 40 is equidistant from opposite ends 36, 38. The location of opposite ends 36, 38 is determined by the semi-minor axis “B” of each overlapping ellipsoid 32, 34.

Body 20 is comprised of solid transparent material such as glass. Body 20 may also be composed of quartz, fused silica, crown glass, plastic (acrylic, polycarbonate), or any other suitable material. Central spherical cavity 42 is filled with fluid such as rare earths or additives used to produce different light colors or effects according to the desired application. Light source 12, such as a filament, arc, or plasma, is maintained between oppositely extending electrodes 14 which suspend the light source 12 across a second equatorial plane 48 coincident with electrodes 14 through spherical cavity 42. In this regard, light source 12 perpendicularly intersects first equatorial plane 40. Such an alignment promotes total internal reflection of light emitted from light source 12 off walls 22 of body 20 to opposite ends 36, 38.

The geometrical relationships of the dual ellipsoid configuration will now be described in greater detail. The alignment of overlapping first and second semi-ellipsoid geometries 32, 34 is determined according to the coincidal of the associated focal point “C” for each ellipsoid 32, 34. The resulting dual ellipsoidal geometry allows light emitted from light source 12 to reflect from a more refractive medium n₁ (e.g., glass) to a less refractive medium n₂ (e.g., air) at an angle greater than the critical angle described by Snell's law or

$$\frac{SIN {θ}_{1}}{SIN {θ}_{2}} = {n}_{21} ,$$

thus achieving the emission of light rays 50 at each end 36, 38 by total internal reflection. The critical angle is the angle of incidence for which the angle of refraction is

$$SIN {θ}_{C} = \frac{{n}_{2}}{{n}_{1}}$$

where n₂ of air=1;

$$SIN {θ}_{C} = \frac{1}{{n}_{1}} .$$

Because the geometrical configuration of walls 22 of body 20 provide total internal reflection, the walls 22 effectively operate as the reflector. Therefore, bulb 10 is the reflector and the use of an external reflector is not needed. This configuration increases efficiency by eliminating an efficiency loss associated with incorporating a secondary reflector.

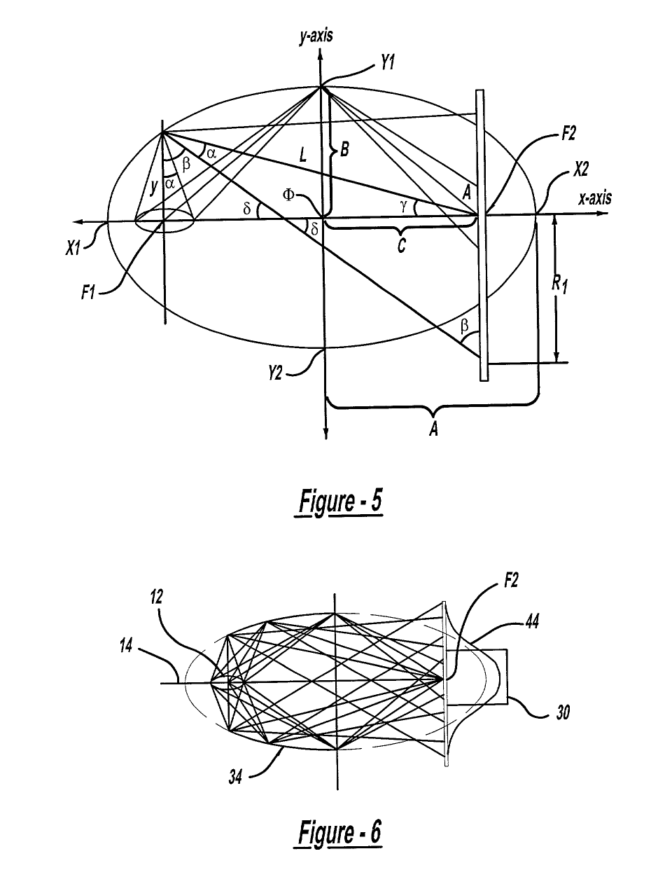

The principles of operation are more readily understood with reference to FIG. 5, which shows a basic ellipse according to the equation (x/A)²+(y/B)²=1. The basic ellipse includes x and y axis intersecting at a point Φ. The y axis intersects the basic ellipse at points y1 and y2, and the x axis intersects the basic ellipse at points x1 and x2. A semi-major axis A extends between points Φ and x2. A semi-minor axis B extends between point Φ and y1. The basic ellipse provides focal points F1 and F2. A distance C extends between point Φ and F2. The following relationships further define the elliptical geometry where:

L={square root over (((2C)²+y²))}

@x=C

y=B{square root over ((1−(C/A)²))}

β=90−γ−α

γ=arc tan(y/2C)

α=arc tan(AG/(2y))

R_{I}=(2C/tan β)−y

D_{I}=2((2C/tan β)−y)

In use, half of the basic ellipse shown in FIG. 6 is truncated at one end through a plane extending through its focal point. With reference to FIG. 6, one-half of a basic ellipse is shown with a truncated end in planar alignment with focal point F1. Further, a target 30, such as a fiber bundle or light pipe, is positioned at focal point F2 for the basic elliptical shape. The gausian intensity distribution is shown at reference 44. From this basic shape and basic ellipse equation above, the diameter of the illuminated zone D_{I} can be determined according to the following equation, where Dₛₚₒₜ, or the diameter of target 30, equals one-half D_{I} and AG is the arc gap or filament length. The equation may be approximated by:

$${D}_{I} = AG \sqrt{\frac{4}{{( B / C )}^{2} - {( B / A )}^{2}} + 1} ,$$

or more accurately defined as:

$${D}_{I} = 2 [ ( \frac{2 C}{tan β} ) - y ]$$

where β=90−γ−α; α=tan⁻¹(AG/2y); γ=tan⁻¹(y/2C).

Turning now to FIG. 4, a ray trace model illustrating the light 50 emitted from bulb 10 is shown. Opposite ends 36, 38 are oriented to allow light transfer devices such as fiber optic bundles or light pipes to be attached thereto.

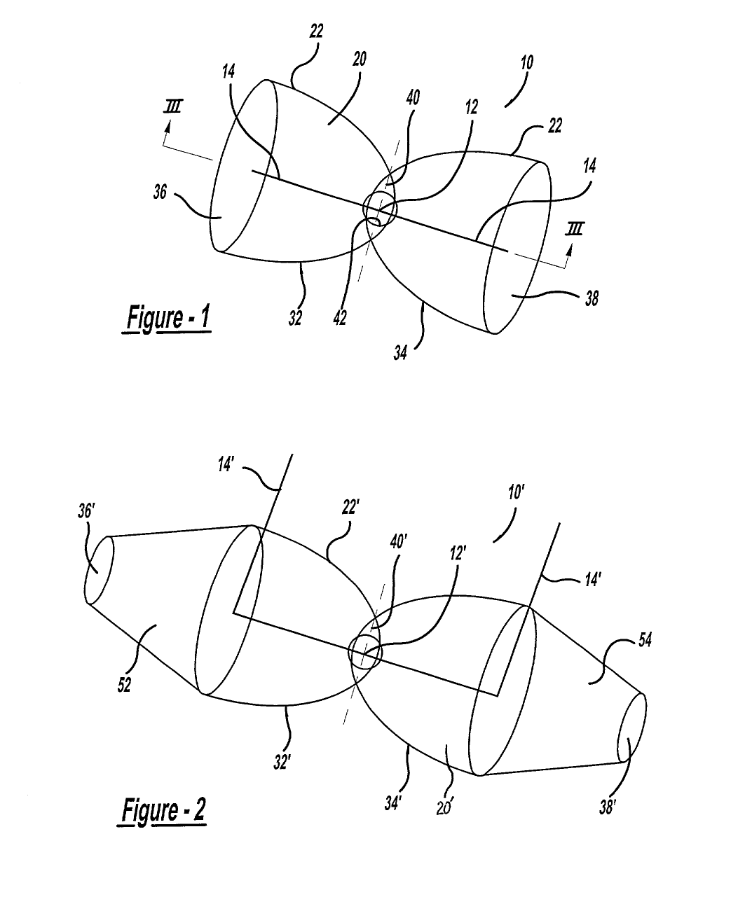

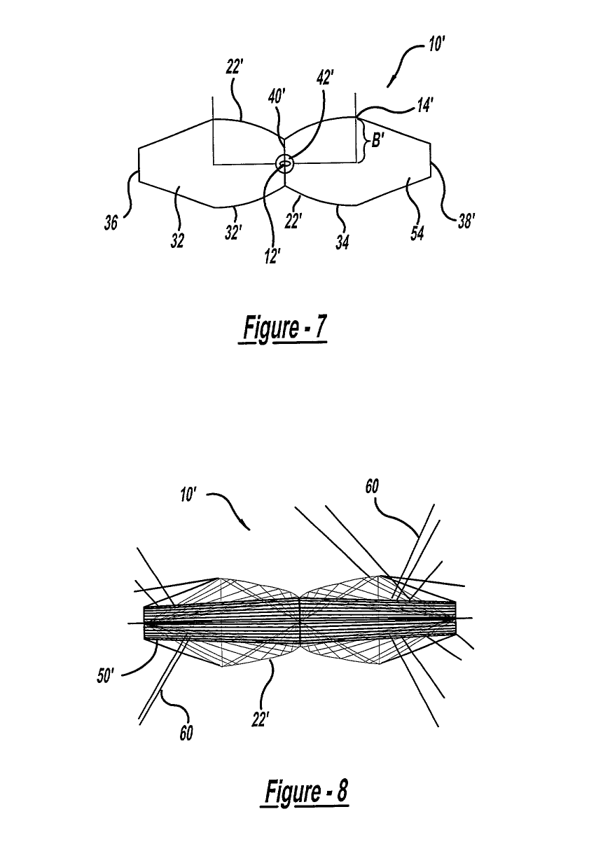

Referencing FIGS. 2, 7 and 8, the bulb constructed in accordance to a second embodiment is illustrated. The use and construction of bulb 10′ has many common aspects as compared to the bulb 10 of the first embodiment. Accordingly, like reference numerals have been used in the drawings to identify substantially identical features of the embodiments.

Bulb 10′ includes walls extending in an elliptical contour outwardly from a plane dividing central spherical cavity. The elliptical contour extends on each side to an intermediate plane defined by the semi-minor axis “B′” of each overlapping semi-ellipsoid 32′, 34′. Electrodes 14′ are arranged to extend outwardly toward opposite ends 36′, 38′ to axis “B′” whereby the electrodes extend along axis “B′” to walls 22′. The electrodes are conductors that carry the current from a lead wire (not shown) through the body 20′ into the spherical cavity 42′. The walls 22′ conically extend from each semi-minor axis “B′” toward opposite ends 36′, 38′ defining conical end portions 52, 54. The conical end portions 52, 54 provide a mounting structure which is favorable in certain applications.

FIG. 8 is a ray trace of bulb 10′. Light rays 50′ reflect off walls 22′ and are directed toward opposite ends 36′, 38′. Rays 60 represent minimal inefficiencies which would not enter the bundle.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A light emitting apparatus comprising:
a body having walls defining a source focal point within said body and target focal points adjacent opposite ends of said body; and
a light source disposed within said body at said source focal point;
wherein the walls of said body cause total internal reflection of light emitted from said source focal point to said target focal points.

2. The light emitting apparatus of claim 1, wherein said light source includes a filament.

3. The light emitting apparatus of claim 1, wherein said light source extends between two electrodes.

4. The light emitting apparatus of claim 1, wherein said body further comprises glass.

5. The light emitting apparatus of claim 1, wherein said body is further defined by a central cavity at said source focal point.

6. A light bulb for reflecting internally generated light, said light bulb comprising:
a body having walls defining a source focal point within said body and target focal points adjacent opposite ends of said body, said walls defined by a first and second overlapping semi-ellipsoids, said opposite ends defined by conical end portions extending from said semi-ellipsoids; and
a light source disposed within said body at said source focal point, said walls of said body causing total internal reflection of light emitted from said light source to said target focal points.

7. The light bulb of claim 6, wherein said light source includes a filament.

8. The light bulb of claim 7, wherein said light source extends between two electrodes.

9. The light bulb of claim 8, wherein said body further comprises glass.

10. The light bulb of claim 6, wherein said body is further defined by a central cavity at said source focal point.

11. A light bulb comprising:
a body having walls defined by a first and second overlapping semi-ellipsoids, said first and second semi-ellipsoids each having distal ends opposite a first focal point and a target focal point proximate each said distal end, said first and second semi-ellipsoids overlapping with said first focal points coinciding to define a source focal point and said distal ends diametrically opposed; and
a light source supported by said body at said source focal point, said walls causing total internal reflection of light emitted by said source to focus at said target focal points.

12. The light bulb of claim 11, wherein said first and second ends are defined by a semi-minor axis of said first and second semi-ellipsoids.

13. The light bulb of claim 11, wherein said light source includes a filament.

14. The light bulb of claim 11, wherein said light source extends between two electrodes.

15. The light bulb of claim 14, wherein said body further comprises glass.
